(19) United States
(12) Patent Application Publication
(10) Pub. No.: US 2006/0195653 A1
(43) Pub. Date: Aug. 31, 2006

(54) Switchable mass storage system

(76) Inventor: Gordon J. Murphy, Glenview, IL (US)

Correspondence Address: GORDON J. MURPHY, 638 GARDEN COURT, GLENVIEW, IL, 60025-4105, US

(21) Appl. No.: 11/065,552

(22) Filed: Feb. 25, 2005

(51) Int. Cl. G06F 12/00; G06F 12/14

(52) U.S. Cl. 711/112; 711/163

(57) ABSTRACT

Switching apparatus is used in combination with a multiplicity of mass storage units to provide a user of a digital computer with privacy from other local users and from users on a connected network. When the computer is connected to the network, the private files are protected from computer viruses, worms, and other pieces of destructive code. When the computer is not connected to a network, various local users can maintain their own programs and data files in complete privacy from other local users and safe from any harm that may have been intended by malicious action directed at the computer from the network. Special-purpose computers and other digital systems can also be protected by the use of such a switched mass memory system.

### BACKGROUND OF THE INVENTION

1. Field of the Invention

The present invention relates generally to the selective isolation of a first set of mass storage units in a digital computer or other digital system from a second set of mass storage units in the same digital computer or other digital system so that information transfer between mass storage units in the first set and mass storage units in the second set is prevented. Thus, when one set of mass storage units is made active, a second set of mass storage units is made inactive or disabled. For example, the first set may consist of a single hard disk and the second set may consist also of a single hard disk. In another embodiment of this invention, for example, the first set again consists of a single hard disk, but the second set may consist of several subsets. Each of those subsets consists of a single hard disk. The disks in the second set are interconnected in such a way that any member of the second set can be enabled with the result that that disk becomes a new first set while the disk that formerly constituted the first set is relegated to a newly formed second set, replacing the newly enabled disk therein. In other embodiments the first set, as well as the second set, may comprise more than one member.

2. Description of the Prior Art

The use of multiple disks in a digital computer is not new. Multiple disks have been used to increase the storage capacity of a computer beyond what is possible with a single disk. Dual booting of digital computers has been employed to permit selection of a particular hard disk or partition from which to boot an operating system in computers in which operating systems have been installed on multiple hard disks and/or partitions. The selection has been made by software means, and all hard disks and/or partitions have been accessible by software after the operating system has been booted. Thus, file transfer among all of the hard disks/partitions in the computer has been possible after the booting operation has been completed.

This capability to access all files stored in the computer, regardless of which disk contains the operating system that was booted, has been considered important because it allows storage of files on any desired disk or partition, to implement a desired filing system, for example, without loss of access to any file in the system.

Multiple disks have been used also to increase the reliability of a computer, by providing multiple copies of the information stored in the computer on separate disks. In such a system, if one disk should fail, the stored data can be retrieved from another disk.

RAID (Redundant Array of Inexpensive Disks) systems have been used to enhance performance in a number of ways. Disk striping, a process of distributing data reads and writes across multiple disks, reduces the effect of head seek time on speed of data transfer. Disk mirroring and duplexing provide protection against loss of data by writing duplicate data to different disks. Error correcting code in a RAID provides some protection against data loss by storing a check sum on the disk.

In all of these previous multiple disk systems, all disks are or can be enabled concurrently, and data and programs stored on one disk can be transferred to another disk. Consequently, a destructive program or piece of code that is admitted to one disk can contaminate all disks in the system.

A purpose of this invention is to provide isolation of one or more mass storage units, such as hard disks, from another mass storage unit or group of mass storage units, to ensure privacy of data and programs and to protect against hacking and other harmful or destructive attacks directed at a digital system.

External hard disks have been used to provide increased storage capacity and portability of files. Such hard disks do not, however, provide the isolation made available with this invention, because the external hard disks heretofore available can be independently enabled and thus allow for transfer of data and program code among them and between them and internal hard disks.

### BRIEF SUMMARY OF THE INVENTION

The essence of the preferred embodiment of this invention is a system for selecting and enabling one or more of a multiplicity of mass storage units for operation at any given time, while disabling others or ensuring that those others are not enabled. That is, those mass storage units that were previously enabled, other than any of the newly selected mass storage units that are in that group, are disabled, and those mass storage units other than the newly selected mass storage units that were previously not enabled are prevented from being enabled. The selecting and enabling operations are performed by a switching apparatus that comprises selecting or identifying apparatus and enabling apparatus. At any given time each one of the multiplicity of mass storage units has an enabled status, which may be either enabled or not enabled, and that enabled status is determined by the switching apparatus.

The selection of one or more of the multiplicity of mass storage units for operation at any given time may be made by hardware or by firmware or software. One of the mass storage units may be a primary mass storage unit, regarded as a part of a computer itself, while the remaining mass storage units collectively are a part of the apparatus disclosed by this invention. Alternatively, all of the mass storage units collectively may be a part of the apparatus disclosed by this invention.

In another form, the invention comprises the selection and enabling apparatus, but not the mass storage units. Again, the enabling apparatus is capable of enabling one or more of a multiplicity of mass storage units for operation at any given time, while disabling others or ensuring that those others are not enabled, provided that the mass storage units are added.

In some embodiments, only one mass storage unit is made operational; the other mass storage units in the system are disabled or not enabled. Consequently, it is not possible to exchange files among the various mass storage units, and each mass storage unit defines a distinct digital computer, on the basis of the programs and data stored within it. In effect, multiple digital computers are made available within what appears to be a single digital computer, by the selection of the mass storage unit to be used. Each mass storage unit may employ a distinct operating system, or the same operating system may be used on two or more of the mass storage units.

This invention encompasses all types of mass storage units, regardless of the kind of interface with the rest of the computer, and all kinds of digital systems, special-purpose systems as well as general-purpose digital computers. The interface may be IDE, SCSI, parallel port, USB, Firewire, wireless, optical, or any other kind The digital system may be a mainframe, a personal computer (IBM, IBM-compatible, or Macintosh, for example), or any other kind, including a reservation system and a multifunction telephone, among others.

A more complex system that falls also within the scope of this invention is a system comprising more than two mass storage units, in which any selected combination of those mass storage units can be enabled and the remaining mass storage units disabled or not enabled.

As an example of a simple embodiment, a digital computer can be provided with multiple hard disks. A particular one of the multiple hard disks can be selected by a switching system that may be mechanical, optical, electrical, software, firmware, or some combination thereof; the other hard disks are maintained in an inoperative state. If the switching system is so constructed that a change in the selection of the active disk can be achieved only by use of a distinct key or code for each selection, then each disk can be assigned to a different user, and each user can maintain his files in complete privacy from the other users. The locking device in which the key or code is used may be hardware, software, firmware, or a combination thereof.

As another example, a given computer can be provided with two hard disks. A particular one of the two hard disks can be selected by a switching system that may be mechanical, optical, electrical, software, firmware, or some combination thereof; the other hard disk is maintained in an inoperative state. Thus, it is possible to operate one “computer” offline at times to maintain privacy of data files from a connected network or alternatively operate the other “computer” in the network at other times to allow exchange of information with other computers via the network.

In addition to maintaining privacy of all files on the first “computer” from other users of the network, this system protects the first “computer” from viruses, worms, and all other forms of harmful intrusion transmitted over the network while still allowing uninhibited use of the network on the second “computer”. If disaster strikes, in the form of a virus attack, for example, all of the files on the private “computer” are unaffected. Software on the hard disk that defines the public “computer” can be restored without endangering the private files on the other hard disk, and operation can be resumed with minimal trauma. Only the programs and other files to be used on the network will be kept on the public disk, so only they will need to be restored after disaster strikes. If only a minimal set of programs and other files are stored on the public disk, the effort required to recover from the disaster is minimized.

Even if antivirus software is used, viruses and other harmful pieces of code can infect a computer, because the user has not kept the antivirus software up to date or simply because protection against a new piece of infectious code has not yet been incorporated into the antivirus software by the supplier. Therefore, the use of an isolated disk system can be of benefit to even those users who employ protective software.

The same protection can be achieved, of course, by physically removing one hard disk and replacing it with another. Such a process is cumbersome and time consuming, however. Moreover, it introduces the possibility of causing substantial damage to the computer.

The use of two completely independent conventional computers will provide the same protection against data corruption, but this invention provides the desired capability at a very substantially reduced cost in terms of weight, volume, and dollars.

Although only one of the mass storage units can be activated or operational at any given time in the preferred embodiment, in other embodiments there is no such restriction. In some such embodiments, a single mass storage unit or other proper subset of the totality of mass storage units in the system is activated when power is made available, as described above; but after the computer is in operation, hardware and/or firmware or software can be used to enable one or more other mass storage units, so that data can be exchanged freely among the various units.

Thus, this invention discloses also a hardware multiple boot system, which is more convenient to install and more convenient to operate than existing software multiple boot systems.

Also disclosed by this invention is a switchable mass memory system comprising a group of mass storage units for use with a separate mass storage unit that is a part of another digital system, a switching apparatus for selecting one of the totality of mass storage units, and an enabling apparatus for enabling the selected mass storage unit and ensuring that the other mass storage units are not enabled. The separate mass storage unit may, for example, be the original hard disk in a digital computer, while the switchable mass storage system is an add-on system or upgrade to the digital computer.

To facilitate installation of the switching and enabling system disclosed in this invention in a personal computer, the switching and enabling system can be provided with one or more connectors appropriate for mating with standard connectors provided within a personal computer.

The above and other advantages and features of the invention will be apparent to those skilled in the art from the following descriptions of particular embodiments taken in conjunction with the accompanying drawings.

### BRIEF DESCRIPTION OF THE DRAWINGS

FIG. 1 is a block diagram depicting the major functional units of a switchable mass storage system.

FIG. 2 illustrates one embodiment of this invention, in which solid-state switching of two hard disks is utilized, with protection against inadvertent switching of the disks while power is applied.

FIG. 3 illustrates an embodiment of this invention in which the number of disks from which selection can be made is greater than two, with protection against inadvertent switching of disks while power is applied.

FIG. 4 illustrates the use of a connector to facilitate the connection of the switching apparatus to the power supply in a digital computer.

FIG. 5 depicts one form of lock that can be used to prevent unauthorized activation of mass storage units.

### DETAILED DESCRIPTION OF THE INVENTION

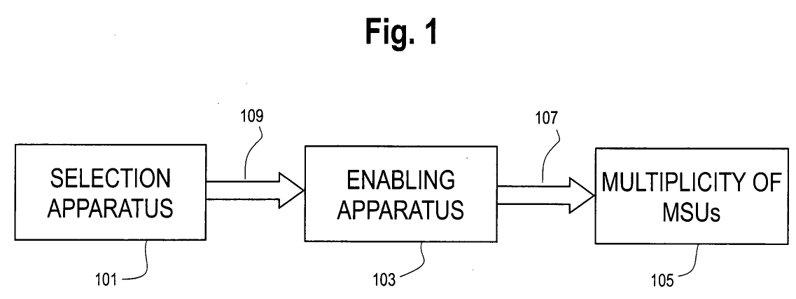

The block diagram in FIG. 1 depicts in a very general way a switchable mass storage system encompassed by this invention. A multiplicity of mass storage units (MSUs) 105 is connected via a first connecting apparatus 107 to enabling apparatus 103 capable of enabling one or more of the multiplicity of MSUs 105 and disabling the remainder of the multiplicity of MSUs 105 or ensuring that they are not enabled. For simplicity of expression, terms such as “disabling the remainder of” and “disable the remainder of” are used hereafter to include “ensuring that they are not enabled” and “ensure that they are not enabled”, respectively, unless the context clearly implies otherwise. Also for simplicity of expression, terms such as “enabling one or more of” or “enable one or more of” are sometimes used hereafter to include disabling other units, unless the context clearly implies otherwise. The particular mass storage units in the multiplicity of MSUs 105 to be enabled are identified by signals provided via a second connecting apparatus 109 to the enabling apparatus 103 by identification or selection apparatus 101. Each of the first connecting apparatus 107 and the second connecting apparatus 109 may contain a connector to facilitate connection. The multiplicity of mass storage units 105, the first connecting apparatus 107, the enabling apparatus 103, the second connecting apparatus 109, and the identification or selection apparatus 101 may be a part of a digital computer, having been installed therein when the digital computer was constructed. In some embodiments of this invention, the second connecting apparatus 109 is absent, because the selection apparatus 101 and the enabling apparatus 103 are the same or are integrated into a combined switching apparatus.

Also encompassed by this invention is a kit comprising the enabling apparatus 103, the first connecting apparatus 107, and one or more mass storage units exclusive of a mass storage unit, regarded as a primary mass storage unit, contained within an existing digital computer to which the kit is intended to be added. Such a kit may be regarded as an upgrade for a digital computer. Some such kits comprise also selection apparatus 101 distinct from the enabling apparatus 103, as well as the second connecting apparatus 109.

Another structure encompassed by this invention comprises the enabling apparatus 103 and the first connecting apparatus 107, but no mass storage unit. Such a structure may also take the form of a kit for upgrading a digital computer, but it may be used with a multiplicity of mass storage units 105, regardless of whether any of the mass storage units is contained within a digital computer. Some such kits comprise also selection apparatus 101 distinct from the enabling apparatus 103, as well as the second connecting apparatus 109.

Although this invention can be implemented by switching one or more control signals (in a set comprising ready, chip select, and drive active, among others, in an IDE interface cable, for example) to the mass storage units, in the preferred implementation it is the power connections that are switched. The mass storage units encompassed by this invention may be but need not be associated with a general-purpose digital computer.

In an IBM personal computer or equivalent, for example, the modification required to switch the power connections to two internal hard disk drives with IDE interfaces serving as MSUs is much simpler to implement than a modification in the control lines. This invention encompasses all forms of MSU, however, including external devices that may be connected to the computer by serial port, parallel port, universal serial bus, Firewire, and any other form of information transfer apparatus.

One embodiment of a switched mass storage system comprises two internal hard disk drives in an IBM PC or an IBM-compatible PC with IDE interface, for example. In this example, the computer originally contained a single hard disk. A switched mass storage system is added, to form an isolated disk system. The added switched mass storage system is an assembly comprising a male connector that mates with one of the female connectors provided in the computer for supplying power to hard disk drives; two female connectors identical to the ones provided in the computer for supplying power to hard disk drives; the additional hard disk drive that is to serve as the isolated disk; and a switching circuit. The +5 volt pin and the +12 volt pin in the male connector are connected as inputs to the switching circuit. The outputs of the switching circuit include a +5 volt wire and a +12 volt wire connected to the appropriate pins in one of the female connectors in the assembly, and a +5 volt wire and a +12 volt wire connected to the appropriate pins in the other female connector in the assembly. The ground pins in the male connector are connected to the ground pins in each of the female connectors, either directly or through the switching circuit The switching circuit is a combination of the selection apparatus 101, the enabling apparatus 103, and the second connecting apparatus 109.

Prior to installation of the isolated disk assembly in the computer, the hard disk in the assembly, which is to be added to the computer, is formatted in the usual way and the desired operating system is installed. Installation of the isolated disk system in the computer consists of a) configuring the hard disk drive in the assembly as a master, b) physically installing the hard disk drive in the assembly in the computer, c) connecting the hard disk drive in the assembly to a hard disk controller cable, using the connectors provided in the computer for that purpose; d) physically installing the structure holding the switching circuit (typically a printed-circuit board mounted on a metal bracket that can be substituted for a cover on one of the slots on the back of the computer, with a switch mounted on the bracket so that it can be actuated from outside the computer); e) connecting the male connector in the isolated disk assembly to one of the female connectors provided in the computer for supplying power to hard disk drives; f) connecting one of the female connectors in the isolated disk assembly to the hard disk drive in the assembly; and g) replacing the female power connector that was originally connected to the original hard disk drive in the computer with the second female connector in the isolated disk assembly. The hard disk in the assembly is then selected, and the computer is booted and an operating system is installed in the usual way.

Thereafter, either hard disk can be selected prior to booting the computer, and the computer will function normally with the selected hard disk serving as the mass storage unit of the computer.

A minor modification of this embodiment is the incorporation of the switch of the isolated disk system in the power switch of the computer so that the power switch has multiple positions: off, on with only the first of the hard drives active, and on with only the second of the hard drives active.

If one of the hard disk drives is configured as a master with slave and the other hard disk drive is configured as a slave, then after the computer has been booted with the master drive, power can be applied to the second drive with a modified form of the switching circuit, so that both hard disk drives can be operated concurrently, under the control of software, in systems in which operation with two operating systems installed is permitted. This would not be done, of course, in a system in which disk isolation is desired.

A very simple form of switching circuit for the isolated drive system comprises a two-pole, double-throw switch. One of the rotors of the switch is connected to the +5 volt supply, and the other rotor is connected to the +12 volt supply. In a first position of the rotors, the stator terminal in contact with the +5 volt rotor is connected to the +5 volt terminal of a first hard disk drive, and the stator terminal in contact with the +12 volt rotor is connected to the +12 volt terminal of that same hard disk drive. In the second position of the rotors of the switch, the stator terminals in contact with the +5 volt rotor and the +12 volt rotor are connected to the +5 volt terminal and the +12 volt terminal, respectively, of a second hard disk drive. In this way, the enabled state of the first hard disk drive and the enabled state of the second hard disk drive are determined by the switching apparatus.

Simplicity and economy are advantages of this kind of switching apparatus; the selection apparatus is the switch, and the enabling apparatus is the same switch.

A disadvantage of this kind of switching circuit is that the switch can be actuated inadvertently while the computer is in operation, which can result in loss of data and malfunction of the software. Clearly, an improved embodiment would inhibit switching except at the time the computer is booted. Such inhibition of switching can be achieved by inhibiting changes in the identification or selection of mass storage units to be enabled except at the time the computer is booted or by inhibiting changes in the disabling/enabling of mass storage units except at the time the computer is booted, regardless of whether changes in identification or selection have been made.

One embodiment of a switching circuit that incorporates such inhibition of switching incorporates a power-on reset kind of circuit (comprising a resistor-capacitor charging circuit or a 555 timer circuit, for example), a single-pole, single-throw switch, and a relay with a holding contact. When the computer is booted, the +12 volt supply is connected for only a short interval of time (the power-on delay time) to the rotor of the single-pole, single-throw switch. The stator terminal of the switch is connected to one terminal of the relay coil; the other terminal of the relay coil is grounded. The relay has three sets of double-throw contacts (i.e., form C). Two of the three sets of contacts are connected as the terminals on the double-pole, double-throw switch in the previous example. The third set of contacts on the relay is used as a holding circuit.

If the switch was open, and hence the first disk drive was selected, at the time the computer was booted, the relay is not actuated at boot-up; and it cannot be actuated after the power-on delay time has expired because the voltage applied to the rotor of the single-pole, single-throw switch is then zero. Therefore, the selection of disk drive to be used cannot be changed in that event.

If the switch was closed, and hence the second disk drive was selected, at the time the computer was booted, the relay is actuated at boot-up. The holding contacts then serve to maintain the connection from the +12V supply to the relay coil after the power-on delay time has expired. Because of the action of the holding circuit, the selection of disk drive to be used cannot be changed later by changing the state of the switch in that event, either.

Thus, changes in the enabled state of the mass storage units are inhibited except at the time the computer is booted.

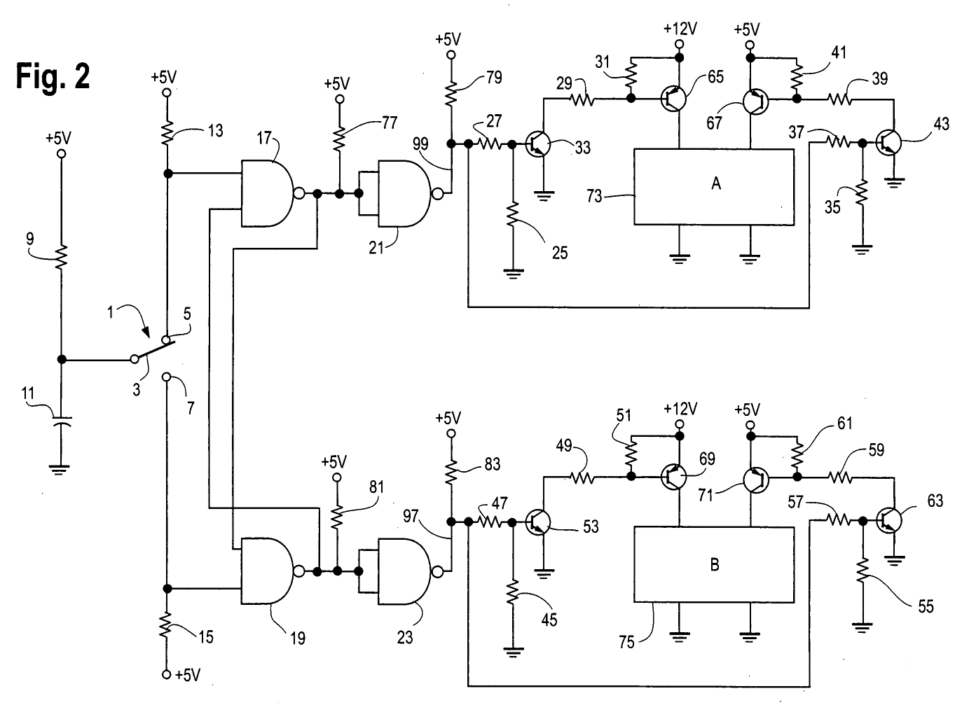

In another, preferred, embodiment the relay of the preceding example is replaced by a solid-state circuit. Such an embodiment is illustrated in the following example, with reference to FIG. 2.

A single-pole, double-throw switch 1 is used instead of a single-pole, single-throw switch because the buffered flip-flop comprised of open-collector NAND gates 17, 19, 21, and 23 and the associated pull-up resistors 13, 15, 77, 81, 79, and 83 has no default state, as does the relay in the embodiment described above. The four open-collector NAND gates 17, 19, 21, and 23 may collectively be a type 7403 integrated circuit, for example. At the instant that power is applied to the circuit, the capacitor 11 begins to charge through the resistor 9, providing a transient logic zero at the rotor 3 of the switch 1. If at that time the rotor 3 is in contact with a first stator 7 of the switch 1, then the flip-flop is forced into its logic 0 state, with a logic 0 at the output of one primary NAND gate 17 and a logic 1 at the output of its associated buffering NAND gate 21. The logic 1 voltage at the output of the buffering NAND gate 21 is applied via a conductor 99 through a first voltage divider comprising two resistors 25 and 27 to the base of a first transistor 33 and through a second voltage divider comprising two other resistors 35 and 37 to the base of a second transistor 43. As a result, the first transistor 33 and the second transistor 43 (each of which may be a 2N2222, for example) are turned on.

A third transistor 65 is turned on by the voltage drop across its base resistor 31 that results from the collector current in the first transistor 33, which appears also in the base resistor 31 and in the collector resistor 29 associated with the first transistor 33. Similarly, a fourth transistor 67 is turned on by the voltage drop across its base resistor 41 that results from the collector current in the second transistor 43, which appears also in the base resistor 41 and in the collector resistor 39 associated with the second transistor 43. Thus, Drive A 73 is enabled or powered on by the +12 volts applied to it through the third transistor 65 and the +5 volts applied to it through the fourth transistor 67. (Each of these power transistors 65 and 67 may be a 2N4920 transistor, for example, but PNP transistors with higher current ratings may be used if Drive A 73 requires more current than the 2N4920 transistor can supply.)

At the same time, the buffered flip-flop provides a logic 1 at the output of a second primary NAND gate 19 and a logic 0 at the output of its associated buffering NAND gate 23. Consequently, a fifth transistor 53, sixth transistor 63, seventh transistor 69, and eighth transistor 71 are prevented from conducting collector currents, and thus Drive B 75 is disconnected from the +5 volt supply and the +12 volt supply.

If, however, at the instant power is applied to the circuit the rotor 3 of the switch 1 is in contact with the second stator 5 of the switch 1, then the flip-flop is forced into its logic 1 state, with a logic 0 at the output of NAND gate 19 and a logic 1 at the output of the buffering NAND gate 23. The logic 1 voltage at the output of the buffering NAND gate 23 is applied via a conductor 97 through a third voltage divider comprising two resistors 45 and 47 to the base of the fifth transistor 53 and through a fourth voltage divider comprising two other resistors 55 and 57 to the base of the sixth transistor 63. As a result, the fifth transistor 53 and the sixth transistor 63, each of which may be a 2N2222, for example, are turned on.

The seventh transistor 69 is turned on by the voltage drop across its base resistor 51 that results from the collector current in the fifth transistor 53, which appears also in the base resistor 51 and in the collector resistor 49 associated with the fifth transistor 53. Similarly, the eighth transistor 71 is turned on by the voltage drop across its base resistor 61 that results from the collector current in the sixth transistor 63, which appears also in the base resistor 61 and in the collector resistor 59 associated with the sixth transistor 63.

Thus, Drive B 75 is enabled or powered on by the +12 volts applied to it through the seventh transistor 69 and the +5 volts applied to it through the eighth transistor 71. Each of these power transistors 69 and 71 may be a 2N4920 transistor, for example, but PNP transistors with higher current ratings, such as the 2N6029 transistor, may be used if Drive B 75 requires more current than the 2N4920 transistor can supply.

At the same time, the buffered flip-flop provides a logic 1 at the output of the first primary NAND gate 17 and a logic 0 at the output of its associated buffering NAND gate 21. Consequently, the first transistor 33, the second transistor 43, the third transistor 65, and the fourth transistor 67 are turned off, and Drive A 73 is disconnected from the +5 volt supply and the +12 volt supply.

After the capacitor 11 has charged, the voltage on the rotor 3 of the switch 1, and hence the voltage on whichever of the stator terminals 5 and 7 is in contact with the rotor 3, is a logic 1 voltage. If the state of the switch 1 is changed after the capacitor 11 has charged, therefore, the buffered flip-flop does not respond, because the inputs to the first primary NAND gate 17 and the second primary NAND gate 19 are both logic 1. That is, the flip-flop memorizes the state of the switch 1 at the instant that power is applied to the circuit, and changing the position of the switch 1 thereafter has no effect on the enabling of Drive A 73 and Drive B 75. Thus, changes in the state of the mass storage units are inhibited except during a short interval of time immediately after power is made available. Although the above description of a preferred embodiment of this invention encompasses the mass storage units represented therein by Drive A 73 and Drive B 75, in other embodiments a switching system, one version of which comprises all components shown in FIG. 2 except Drive A 73 and Drive B 75, can be provided alone, with mass storage units obtained from another source.

Optionally, in such an embodiment the switching system can be provided with one or more connectors such as would be appropriate for mating with a standard power connector for a hard disk drive in a digital computer or a standard power connector on a hard disk drive or both, for example.

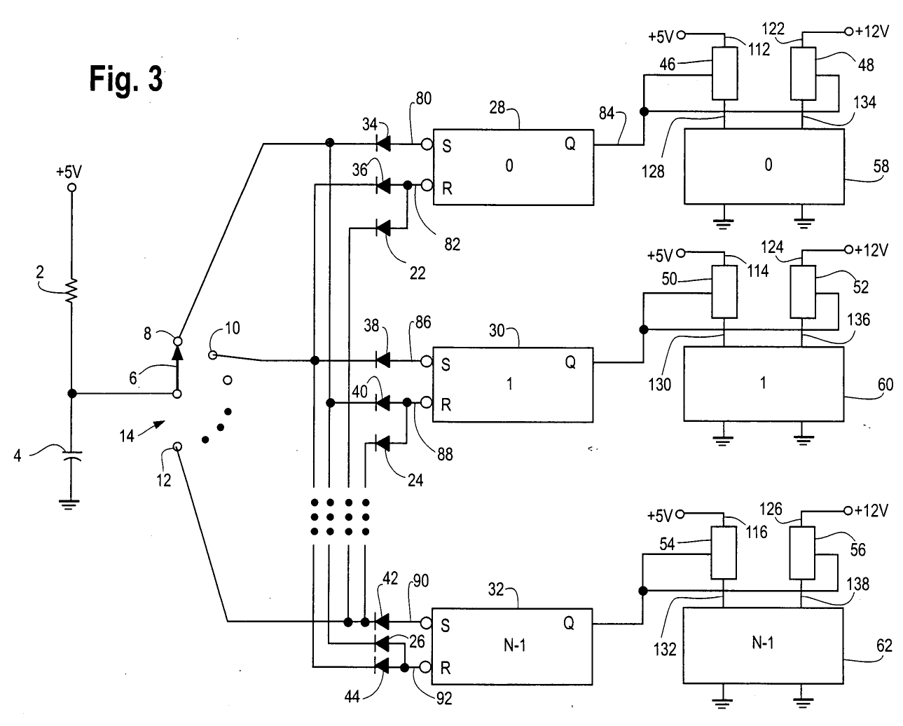

As another example of this invention, a switched disk system comprising more than two disk drives is illustrated in FIG. 3. The total number of disk drives is n; the drives are identified as drive 0 58, drive 1 60, . . . , and drive n-1 62.

Drive 0 58 is enabled by connecting it to the +5 volt power supply via a supply line 112 and another supply line 128 through a first power switch 46, and to the +12 volt power supply via a supply line 122 and another supply line 134 through a second power switch 48. Similarly, drives 1 60, . . . , n-1 62 are connected to the +5V power supply via supply lines 114, . . . , 116 and other supply lines 130, . . . , 132 through power switches 50, . . . , 54, and to the +12V power supply via supply lines 124, . . . , 126 and other supply lines 136, . . . , 138 through power switches 52, . . . , 56. The first power switch 46 shown in FIG. 3 may be regarded as having the structure illustrated in FIG. 2, comprising the resistors 35, 37, 39, and 41, and the transistors 43 and 67; the second power switch 48 shown in FIG. 3 has the structure illustrated in FIG. 2 comprising the resistors 25, 27, 29, and 31, and the transistors 33 and 65. The structure of the power switches 50, 52, . . . 54, and 56 shown in FIG. 3 is similar to the structure of the power switches 46 and 48.

Each drive is enabled by providing a logic 1 at the Q output of the buffered flip-flop associated with that drive, and disabled by providing a logic 0 at the output of the same buffered flip-flop. The buffered flip-flops are identified as buffered flip-flop 0 28, buffered flip-flop 1 30, . . ., and buffered flip-flop n-1 32. Each buffered flip-flop illustrated in FIG. 3 may be regarded as having the structure formed by the first NAND gate 17, the second NAND gate 19, the third NAND gate 21, and the fourth NAND gate 23 shown in FIG. 2, in combination with the resistors 13, 15, 77, 81, 79, and 83 shown in the same figure.

The buffered flip-flop 28 shown in FIG. 3 will provide a logic 1 signal at its Q output terminal 84 when a logic 0 signal is applied at its input terminal 80 labeled S and will retain the logic 1 signal at its Q output terminal 84 thereafter until a logic 0 signal is applied at its input terminal 82 labeled R. The signal at the Q output 84 of the buffered flip-flop 28 then changes to a logic 0 signal. After the logic 0 signal appears at the Q output terminal 84 of the buffered flip-flop 28, the buffered flip-flop 28 will retain the logic 0 signal at its Q output terminal 84 until a logic 0 signal is applied at its input terminal 80 labeled S. The other buffered flip-flops 30, . . . , 32 shown in FIG. 3 operate in the same manner as the first buffered flip-flop 28.

A logic 0 signal is applied to buffered flip-flop 0 28 at the input terminal 80 labeled S via a diode 34 during the time interval in which the voltage on the charging capacitor 4 is low if the rotor 6 of the selector switch 14 is in contact with the first stator terminal 8 of the selector switch 14 during that interval. When a logic 0 signal is applied to buffered flip-flop 0 28 at the input terminal 80 labeled S, that logic 0 signal is applied also to buffered flip-flop 1 30, . . . , and buffered flip-flop n-1 32 at their input terminals 88, . . . , 92 labeled R, via isolating diodes 40, . . . , 26. The isolating diodes 36, 22, 40, 24, . . . , 26, and 44 are required to prevent logic 0 signals applied to the R input of one buffered flip-flop from affecting the R input of another buffered flip-flop. The diodes 34, 38, . . . , and 42 are included to assure that the logic 0 signals presented to the flip-flops 28, 30, . . . , and 32 at their input terminals 80, 86, . . . , and 90 labeled S have the same voltage level as the logic signals presented to the same flip-flops at their inputs 82, 88, . . . , and 92 labeled R.

Similarly, a logic 0 signal can be applied via a diode 38 to buffered flip-flop 1 30 at its input terminal 86 labeled S and via isolating diodes 36, . . . , and 44 to all of the other buffered flip-flops at their input terminals 82, . . . , and 92 labeled R, if the rotor 6 of the selector switch 14 is in contact with terminal 10 of the selector switch 14. In the same way, a logic 0 signal can be applied via a diode 42 to buffered flip-flop n-1 32 at its input terminal 90 labeled S and via isolating diodes 22, 24, . . . to all of the other buffered flip-flops 28, 30, . . . at their input terminals 82, 88, . . . labeled R, if the rotor 6 of the selector switch 14 is in contact with the stator terminal 12 of the selector switch 14.

Thus, by putting the rotor 6 of the selector switch 14 in contact with the appropriate stator terminal 8, 10, . . . , or 12 before power is applied to the switching circuit, it is possible to enable any one of the drives 58, 60, . . . , 62 and disable all of the remaining drives for as long as power is present.

Because the capacitor 4 charges through a resistor 2, the voltage on the capacitor 4, and hence the logic signal applied to the rotor 6 of the selector switch 14, remains low for only a brief time after power is applied to the switching circuit; therefore, the selection of the disk drive to be enabled cannot be changed until after power has been removed from the switching circuit.

In another version of this embodiment of the invention, provision is made also for the selection of any desired distinct combination of n disk drives. This can be accomplished, for example, by modifying the system illustrated in FIG. 3 as follows. For each desired distinct combination of disk drives in FIG. 3, an additional stator terminal is added to the selector switch 14; then the cathodes of n additional diodes are connected to that stator terminal, and a connection is made from the anode of each of those diodes to the input terminal labeled S of the buffered flip-flop associated with a distinct drive in the combination to be selected and to the R input of the buffered flip-flop associated with a distinct one of all other drives. If there are to be m drives in the combination to be selected, there will be connections through diodes to the additional stator terminal of the selector switch 14 from the input terminals labeled S of m buffered flip-flops and connections through diodes to the same stator terminal of the selector switch 14 from the input terminals labeled R of n-m buffered flip-flops.

If in a given digital system there can be only one master in operation at any given time, the master/slave jumpers on the various disk drives can be incorporated in the switching system so that, for any given position of the rotor 6 of the switch 14 there is only one master and the other enabled drives are configured as slaves. Such a requirement exists, for example, in IBM personal computers and IBM-compatible personal computers, where each disk drive controller cable can support only one master disk drive and a second disk drive connected to the same cable must be configured as a slave. In order for this configuration to be usable, the computer must allow operation with multiple operating systems present concurrently, however. Alternatively, the disks can be configured for cable select operation where permitted.

In some embodiments of this invention, a first group of mass storage units is enabled at all times the system is in operation; and one or more of the remaining mass storage units in the system are identified to be enabled and the remainder disabled as described above.

Thus, it is seen that in some preferred embodiments this invention comprises a system for a) selecting one or more of a multiplicity of mass storage units associated with a digital computer at a time when none of that group of mass storage units is operational or enabled, and b) preventing a change in selection after that one or more mass storage units have been enabled or made operational and the remainder have been disabled. The selection may be made by hardware, firmware, or software. The selection may be made by use of an independent switch, and it may be made by a modified power switch or by a modification of the computer shutdown/restart menu, for example.

In other embodiments, after one mass storage unit has been selected by a hardware system and enabled, one or more other mass storage units may be enabled in addition, by hardware, firmware, or software, while at least one additional mass storage unit is disabled. This can be done, for example, by modifying the computer's BIOS and/or its configuration file, or by adding a second switch, to be actuated at some time after the first mass storage unit has been enabled.

In still other embodiments of this invention, a digital computer with multiple mass storage units is booted in the conventional way; then, at a later time, one or more of the mass storage units are disabled in an orderly manner so as to prevent loss of data and/or damage to software, while the remaining mass storage units remain enabled, with rebooting if necessary on one of the mass storage units not disabled. In this way it is possible, for example, to provide protection against hackers from all other users of a network and achieve total privacy of all files on the mass storage units that were disabled. As a result, the disabled mass storage units are protected from viruses, worms, and all other forms of harmful intrusion transmitted over the network while still allowing uninhibited use of the network on the mass storage units that remain enabled.

The enabling of one group of mass storage units and the disabling of others may be accomplished by hardware, firmware, or software. This can be done, for example, by modifying one or more signals in the control cables connected to one or more of the mass storage units, by modifying the computer's BIOS and/or its configuration file, by putting one or more of the mass storage units in the sleep mode or the standby mode, or by adding a second switch, to be actuated at some time after the first mass storage unit has been enabled.

In still other embodiments of this invention, a first multiplicity of mass storage units may be enabled without switching, and a second multiplicity of mass storage units may be enabled by switching, as described previously.

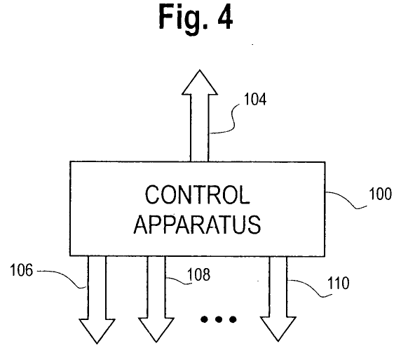

An example of an assembly without a mass memory unit, which is nevertheless encompassed by this invention, is illustrated in FIG. 4. Control apparatus 100 serves to interface a multiplicity of mass storage units such as drive 0 58 in FIG. 3, drive 1 60 in FIG. 3, . . . , and drive n-1 62 in FIG. 3 to the power supply in a digital computer. The control apparatus 100, which comprises the enabling apparatus 103 shown in FIG. 1 and may comprise also distinct selection apparatus 101 shown in FIG. 1, is connected to the +5V supply and the +12V supply in a digital computer by connecting apparatus 104, which may comprise a connector to simplify connection and removal. For example, the connecting apparatus 104 may provide +5V to power switch 46 in FIG. 3 on conductor 112, to power switch 50 in FIG. 3 on conductor 114, . . . , and to power switch 54 in FIG. 3 on conductor 116; and the same connecting apparatus 104 may provide +12 V to power switch 48 in FIG. 3 on conductor 122, to power switch 52 in FIG. 3 on conductor 124, . . . , and to power switch 56 in FIG. 3 on conductor 126. Similarly, the control apparatus 100 is connected to the +5V supply line 128 and the +12V supply line 134 on drive 0 58 in FIG. 3 by connecting apparatus 106, which may contain a connector to facilitate connection to drive 0 58, to the +5V supply line 130 and the +12V supply line 136 on drive 1 60 in FIG. 3 by connecting apparatus 108, which may contain a connector to facilitate connection to drive 1 60, . . . , and to the +5V supply line 132 and the +12V supply line 138 on drive n-1 62 in FIG. 3 by connecting apparatus 110, which may contain a connector to facilitate connection to drive n-1 62. The ground connections to drive 0 58, drive 1 60, . . . , and drive n-1 62 may extend directly from the power supply connecting apparatus 104 to the disk drive connecting apparatus 106 for drive 0 58, the connecting apparatus 108 for drive 1 60, . . . , and the connecting apparatus 110 for drive n-1 62; or the ground connections may pass through the control apparatus 100.

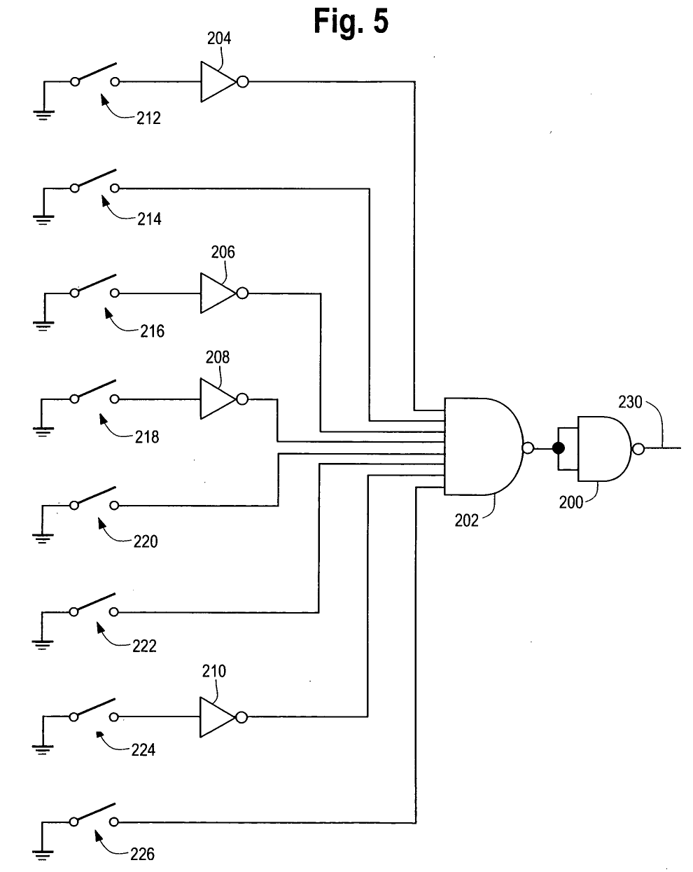

As has been mentioned above, one highly desirable aspect of this invention is that it provides privacy from other users of a common digital computer. Such privacy may be obtainable by cooperation among users, but it can be assured, if desired, by provision of a locking device, which may be electronic or mechanical or a combination of the two. One example of a lock appropriate for this purpose is shown in FIG. 5.

Single-pole, single-throw switches 212, 214, 216, 218, 220, 222, 224, and 226 are configured as an input keypad that is provided with a mechanical lock to prevent changes in the state of the keys by those who do not possess a key. If the switches are regarded as input keys in a natural binary representation, with the uppermost key 212 having the most significance and the lowermost key 226 having the least significance, then the electrical signals appearing at the inputs to the 8-input NAND gate 202 will form a natural binary code corresponding to the natural binary code entered via the switches 212, 214, . . . , 226. The output of the NAND gate 202, which may be a type 7430 integrated circuit, for example, is inverted by a two-input open-collector NAND gate 200 operating as an inverter, with the result that the output voltage of the two-input open-collector NAND gate 200 is high if and only if the eight inputs to the NAND gate 202 are all high. The two-input open-collector NAND gate 200 may be a part of a type 7403 quad two-input open-collector NAND gate, for example.

Because the outputs of input keys 212, 216, 218, and 224 are inverted, by inverters 204, 206, 208, and 210, respectively, the eight inputs to the 8-input NAND gate 202 will all be high if and only if the input code entered via the keypad is 01001101. Each of the inverters 204, 206, 208, and 210 may be a part of a type 7404 hex inverter, for example.

The output terminal of the two-input open-collector NAND gate 200 may be connected via a conductor 230 to the conductor 99 at the output of NAND gate 21 in FIG. 2, for example. Then the output of the NAND gate 21 will be held low by NAND gate 200, regardless of whether drive A 73 in FIG. 2 is selected by the selector switch 1, unless the code entered on the keypad comprising keys 212, 214, . . . , 226 is 01001101. Thus, all users of the common digital computer except for those who know the code and have a key that provides access to the keypad for data entry are prevented from activating drive A 73.

Circuitry similar to that shown in FIG. 5, with distinct access codes, can be connected to one or more of the input lines, such as conductor 84 in FIG. 3, for example, to the enabling apparatus in a system such as that illustrated in FIG. 3. Thus, access to all of the mass storage units, such as drive 0 58, drive 1 60, . . . , and drive n-1 62 or any desired subset thereof can be limited.

Optionally, a different kind of electronic lock, similar to that used to limit access to a home, for example, may be used instead of the lock shown in FIG. 5. In some such locks, the input keys 212, 214, . . . , 226 are replaced with momentary contact keys, and a form of memory is added to retain the last code or combination entered. As a result, there is no need for a mechanical lock. Such an electronic lock can also be connected to the conductor 99 at the output of NAND gate 21 in FIG. 2, for example, to achieve the same result as the lock illustrated in FIG. 5.

Although the invention disclosed herein has been described with reference to specific embodiments, various modifications and improvements will occur to those skilled in the art. It is to be understood, therefore, that this invention is not limited to the particular forms illustrated, nor to particular devices known at present, but includes all arrangements of apparatus that do not depart from the spirit and scope of the appended claims and specific devices now known or to be developed in the future.

What I claim as my invention is:

1. Apparatus for selecting and enabling one or more of a multiplicity of mass storage units and disabling the remainder of said multiplicity of mass storage units or ensuring that they are not enabled that performs the functions of
(a) selecting or identifying which one or more of said multiplicity of mass storage units are to be enabled; and
(b) enabling said one or more of said multiplicity of mass storage units and disabling those of said multiplicity of mass storage units that are not so identified or ensuring that they are not enabled.

2. Apparatus for selecting and enabling one or more of a multiplicity of mass storage units and disabling the remainder of said mass storage units or ensuring that they are not enabled as claimed in claim 1, comprising:
(a) selection apparatus for identifying which one or more of said multiplicity of mass storage units are to be enabled; and
(b) apparatus for enabling said one or more of said multiplicity of mass storage units and disabling those of said mass storage units that are not so identified or ensuring that they are not enabled.

3. Apparatus for selecting and enabling one or more of a multiplicity of mass storage units and disabling the remainder of said mass storage units or ensuring that they are not enabled as claimed in claim 1 comprising apparatus to inhibit a change in the enabled status of any of said multiplicity of mass storage units except during a short interval of time immediately following the time at which power is made available.

4. Apparatus for selecting and enabling one or more of a multiplicity of mass storage units and disabling the remainder of said mass storage units or ensuring that they are not enabled as claimed in claim 1, wherein the mass storage units in a subset of said one or more mass storage units are enabled at all times the system is in operation, regardless of which other mass storage units are enabled at any given time.

5. Apparatus for selecting and enabling one or more of a multiplicity of mass storage units and disabling the remainder of said mass storage units or ensuring that they are not enabled as claimed in claim 1, wherein
(a) the mass storage units in a subset of said one or more of a multiplicity of mass storage units are enabled at all times the system is in operation, regardless of which other mass storage units are enabled at any given time; and
(b) changes in the enabled status of any of said multiplicity of mass storage units are inhibited except during a short interval of time immediately following the time at which power is made available.

6. Apparatus for selecting and enabling one or more of a multiplicity of mass storage units and disabling the remainder of said mass storage units or ensuring that they are not enabled as claimed in claim 1 comprising a connector for mating with a connector provided within a digital computer.

7. Apparatus for selecting and enabling one or more of a multiplicity of mass storage units and disabling the remainder of said mass storage units or ensuring that they are not enabled as claimed in claim 1 comprising a locking device for limiting access to one or more of said multiplicity of mass storage units.

8. Apparatus for selecting and enabling one or more of a multiplicity of mass storage units and disabling the remainder of said mass storage units or ensuring that they are not enabled as claimed in claim 1 wherein
(a) changes in the enabled status of any of said multiplicity of mass storage units are inhibited except during a short interval of time immediately following the time at which power is made available; and
(b) a locking device is provided for limiting access to one or more of said multiplicity of mass storage units.

9. Apparatus for selecting and enabling one or more of a multiplicity of mass storage units and disabling the remainder of said mass storage units or ensuring that they are not enabled as claimed in claim 6 further comprising a hard disk drive.

10. Apparatus for selecting and enabling one or more of a multiplicity of mass storage units and disabling the remainder of said mass storage units or ensuring that they are not enabled as claimed in claim 1 wherein
(a) changes in the enabled status of any of said multiplicity of mass storage units are inhibited except during a short interval of time immediately following the time at which power is made available;
(b) a locking device is provided for limiting access to one or more of said multiplicity of mass storage units; and
(c) a hard disk drive is further provided.

11. Apparatus for interfacing a multiplicity of mass storage units to the power supply in a digital computer, comprising
(a) control apparatus for enabling a selected one or more of said multiplicity of mass storage units; and
(b) connecting apparatus for connecting said control apparatus to said power supply in a digital computer.

12. Apparatus for interfacing a multiplicity of mass storage units to the power supply in a digital computer as claimed in claim 11, further comprising distinct selecting apparatus for selecting said one or more of said multiplicity of mass storage units.

13. Apparatus for interfacing a multiplicity of mass storage units to the power supply in a digital computer as claimed in claim 11, further comprising apparatus to inhibit changes in the enabled status of any of said multiplicity of mass storage units except during a short interval of time immediately following the time at which power is made available.

14. Apparatus for interfacing a multiplicity of mass storage units to the power supply in a digital computer as claimed in claim 11, further comprising a locking device for limiting access to one or more of said multiplicity of mass storage units.

15. A switchable mass storage system comprising:
(a) one or more mass storage units;
(b) selection apparatus for identifying the one or more of said one or more mass storage units that are to be enabled; and
(c) apparatus for enabling the one or more of said one or more mass storage units that are so identified and disabling those of said mass storage units that are not so identified or ensuring that they are not enabled.

16. A switchable mass storage system as claimed in claim 15 further comprising apparatus to inhibit a change in the enabled status of any of said one or more mass storage units except during a short interval of time immediately following the time at which power is made available.

17. A switchable mass storage system as claimed in claim 15 wherein the mass storage units in a subset of said mass storage units are enabled at all times the system is in operation, regardless of which other mass storage units are enabled at any given time.

18. A switchable mass storage system as claimed in claim 15 further comprising a locking device for limiting access to one or more of said mass storage units.

19. A switchable mass storage system as claimed in claim 15 wherein said selection apparatus for identifying the one or more of said one or more mass storage units that are to be enabled comprises computer code.

20. A switchable mass storage system as claimed in claim 15 comprising also a digital computer connected to said one or more mass storage units, wherein changes in the identification and enabling of mass storage units can be made after said digital computer has been booted.
